(19) United States
(12) Patent Application Publication
(10) Pub. No.: US 2005/0267800 A1
(43) Pub. Date: Dec. 1, 2005

(54) Method, system and computer program for providing a loyalty engine enabling dynamic administration of loyalty programs

(76) Inventors: Terrance Patrick Tietzen, Edmonton (CA); Mark Marcel Archinuk, Edmonton (CA); Russell Patrick Lang, Edmonton (CA); Steve Lam, Edmonton (CA)

Correspondence Address: MILLER THOMPSON, LLP, 20 QUEEN STREET WEST, SUITE 2500, TORONTO, ON, M5H 3S1, CA

(21) Appl. No.: 10/855,327

(22) Filed: May 28, 2004

(51) Int. Cl. G06F 17/60

(52) U.S. Cl. 705/14

(57) ABSTRACT

A method, computer system, and computer program product for encouraging customer loyalty is provided. The method includes the steps of: (1) one or more members defining a loyalty program, the loyalty program defining loyalty reward points associated with one or more activities; (2) registering one or more participants with the loyalty program, whereby their registration includes the provision of financial card data for one or more financial cards of each of the one or more participants; (3) collecting financial data corresponding to transactions of the one or more participants associated with the one or more members, and providing said financial data to a loyalty engine; (4) providing access to the loyalty engine to the one or more members, the loyalty engine permitting the one or more members: (a) to define the rules defining the loyalty program, including accumulation of loyalty reward points, and redemption of loyalty reward points; (b) monitoring the effectiveness of the loyalty program; and (c) modifying the loyalty program to enhance its effectiveness. The computer system includes the loyalty engine of the invention. The computer program product consists of a server application that includes the loyalty engine of the invention. Members access a number of software utilities linked to the loyalty engine to assess the effectiveness of the loyalty programs and customize the attributes of the loyalty programs on the fly to improve effectiveness. Participants access the loyalty engine to access a virtual real time loyalty reward point account, and redeem loyalty reward points for prizes.

### FIELD OF THE INVENTION

This invention relates to creation and administration of loyalty reward programs. This invention relates more particularly to Internet solutions for creating and administering loyalty reward programs.

### BACKGROUND OF THE INVENTION

Numerous customer loyalty programs are known.

Customer loyalty systems also play an increasingly important role. The use of the Internet in the area of administering loyalty programs is also known.

For example, U.S. application Ser. No. 10/068,469 (Published, Aug. 29, 2002), assigned to International Business Machines Corporation relates to a “Method, Computer System, and Computer Program Product for Processing Customer Loyalty Data”. The invention provides for front-end devices, such as front-end input terminals for inputting of transaction data, such as data specifying goods or services to be purchased by a customer. The front-end devices can be distributed in the field, for example in retail shops, super market and point-of-sale terminals. The front-end devices have a spreadsheet engine which comprises the data processing kernel of a spreadsheet program such as Lotus 1-2-3 or Microsoft Excel. The front-end device advantageously can be integrated with a point-of-sale terminal for a processing of a customer's checkout and payment. Furthermore the invention is advantageous in that it allows the updating of loyalty rules without a need to separately reprogram each of the front-end devices in the field. Changing of loyalty rules in the database of the back-end computer will cause updating of the loyalty rules of the front-end devices when a synchronization occurs. Transaction data between the front-end and the back-end occurs via the Internet.

U.S. application Ser. No. 09/909,194 (Published Jan. 31, 2002) in the name of Michael A. Wilkman, relates to a “Universal Transaction Manager Agent, Systems and Methods”.

This invention provides a transaction engine that enables a user to match and coordinate the use of credit accounts, debit accounts, loyalty (points) programs, affinity (points) programs, promotions, and currency exchanges to enhance the purchase transaction of consumers and businesses. The enhancements may include financial, promotional, or other benefits for various purchases of goods and services thereby enabling merchants to target their incentives to consumers and businesses prior to or at the time of the purchase transactions.

There are a number of disadvantages to the prior art solutions.
Prior art solutions generally require a loyalty ID. Most customer loyalty programs require action from the user to associate the customer loyalty program with the consumer behaviour, for example, use of a special loyalty card, or provision of a loyalty card number. This complicates the deployment of the loyalty program, and also makes it less convenient for the customer to participate.
Many prior art solutions are based on specific incentives, not points, so it is more difficult for a participant to cumulate for a big prize.
Rewards are generally not processed in real time, so a participant has to wait for approximately 24 hours to see the incentive earned.
Loyalty points are generally not redeemed for a prize on site, therefore there is a missed opportunity to further encourage customer loyalty by means of personal interaction.
Prior art solutions do not generally provide a solution that enables customization of loyalty programs on the fly based on effectiveness and incremental cost.

### SUMMARY OF THE INVENTION

One aspect of the present invention is a method of encouraging customer loyalty, including the steps of: (1) One or more members defining a loyalty program, the loyalty program defining loyalty rewards associated with one or more activities; (2) Registering one or more participants with the loyalty program, whereby their registration includes the provision of financial card data for one or more financial cards of each of the one or more participants; (3) Collecting financial data corresponding to transactions of the one or more participants associated with the one or more members, and providing said financial data to a loyalty engine; (4) Providing access to the loyalty engine to the one or more members, the loyalty engine permitting the one or more members: (a) To define the rules defining the loyalty program, including accumulation of loyalty reward points, and redemption of loyalty reward points; (b) Monitoring the effectiveness of the loyalty program; and (c) Modifying the loyalty program to enhance its effectiveness.

Another aspect of the invention is a computer system that includes the described loyalty engine. Another aspect of the invention is a computer program product consisting of the loyalty engine.

In a particular aspect of the invention, the completion of a survey is linked to the accumulation of loyalty reward points.

In yet another particular aspect of the invention, loyalty reward points are redeemed by the participant printing a coupon displayed by the loyalty engine, and presenting the coupon at a location of the applicable member.

In a still other aspect of the present invention, a method, computer system, and computer program product is provided that enables a plurality of members to co-operate to provide loyalty benefits jointly, by operation of the loyalty engine.

### BRIEF DESCRIPTION OF THE DRAWINGS

A detailed description of the preferred embodiment(s) is(are) provided herein below by way of example only and with reference to the following drawings, in which:

FIG. 1 is a system resource diagram illustrating the resources of the system of the present invention.

FIG. 2 is a program resource diagram illustrating the main components of the computer program of the present invention.

FIG. 3 is a flowchart illustrating the participant/member log-in/registration process, in one particular implementation of the present invention.

FIG. 4 is a flowchart illustrating the processes involved in operation of the member area, in one particular embodiment thereof.

FIG. 5 is a further flowchart illustrating the processes involved in operation of the participant area, in one particular embodiment thereof.

FIG. 6 is a flowchart illustrating the processes involved in operation of the reservation utility of the present invention.

FIG. 7 is flowchart illustrating the processes involved in operation of the facility locator or locator utility of the present invention.

FIG. 8 is a flowchart illustrating the processes involved in operation of the member area, which illustrates the services provided to “owners”, in accordance with a particular aspect of the present invention.

FIG. 9 is a flowchart illustrating the processes involved in operation of the loyalty engine to create and administer loyalty programs, in accordance with a particular implementation of the present invention.

FIG. 10 is a flowchart illustrating the processes involved in a participant completing a survey created in accordance with the invention, in one particular embodiment thereof.

FIG. 11 is a flowchart illustrating the processes involved in a participant redeeming a loyalty reward, in a particular implementation of the present invention.

FIG. 12 is a flowchart illustrating the process involved in signing up a participant.

FIG. 13 is a flowchart illustrating the operation of the Customer Relationship Management or CRM utility of the present invention, in a particular embodiment of the present invention.

FIG. 14 is a flowchart illustrating a particular aspect of the reward administration facility, namely the processes involved in awarding prizes to participants.

FIG. 15 is a flowchart illustrating a particular process for obtaining financial data for the United States.

FIG. 16 is a flowchart illustrating a particular process for obtaining financial data for Canada.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

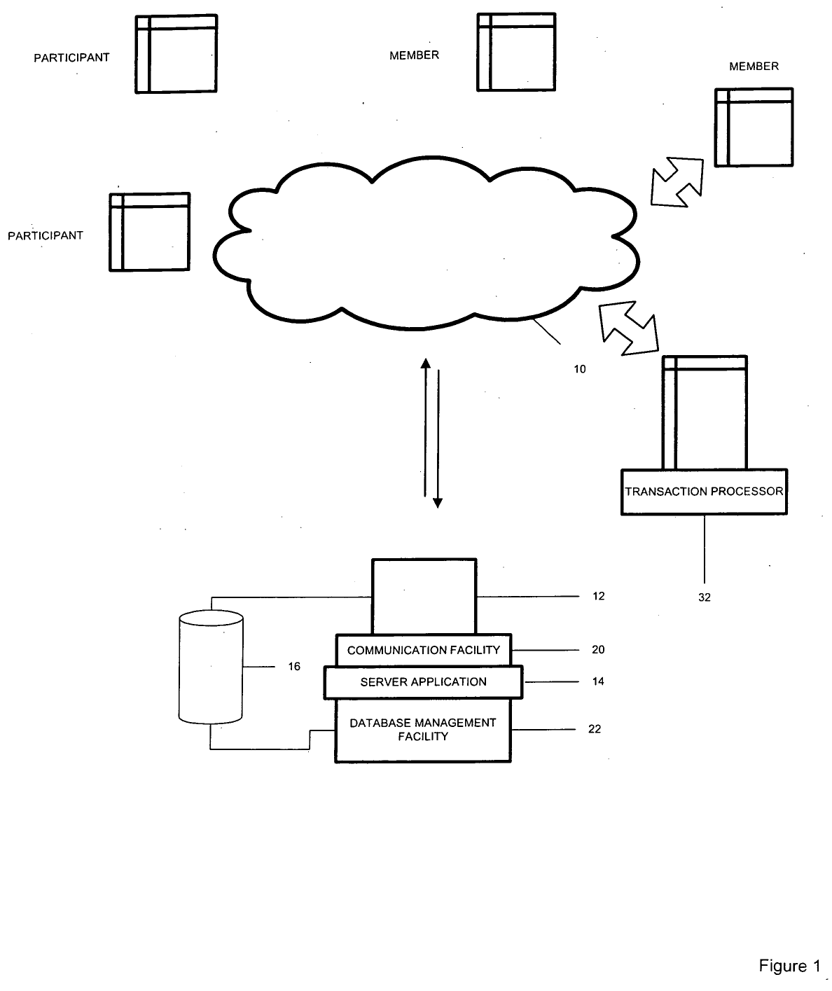

Referring to FIG. 1, there is illustrated a system resource diagram illustrating one aspect of the system of the present invention. By means of the Internet medium (10), a web server (12) is made accessible to a plurality of users (described below).

One aspect of the server computer (12) is that it includes a server application (14) which consists of the computer program of the present invention. The server computer (12) is linked to a known database (16).

In one particular implementation of the present invention, the server computer (12) consists of at least one web server (e.g. an IBM™ HTTP Server), at least one application server (e.g. an IBM™ running WEBSPHERE™ software), and at least one database server (e.g. running IBM™ DB2). In addition, in a particular implementation of the present invention, the server computer (12) also includes a server dedicated to importing real time financial data (as explained above).

One aspect of the server application (14) is that it includes a web utility (17) for publishing a web site (18) to the Internet (10) in a manner that is known. The features of the web site (18) of the present invention are described below.

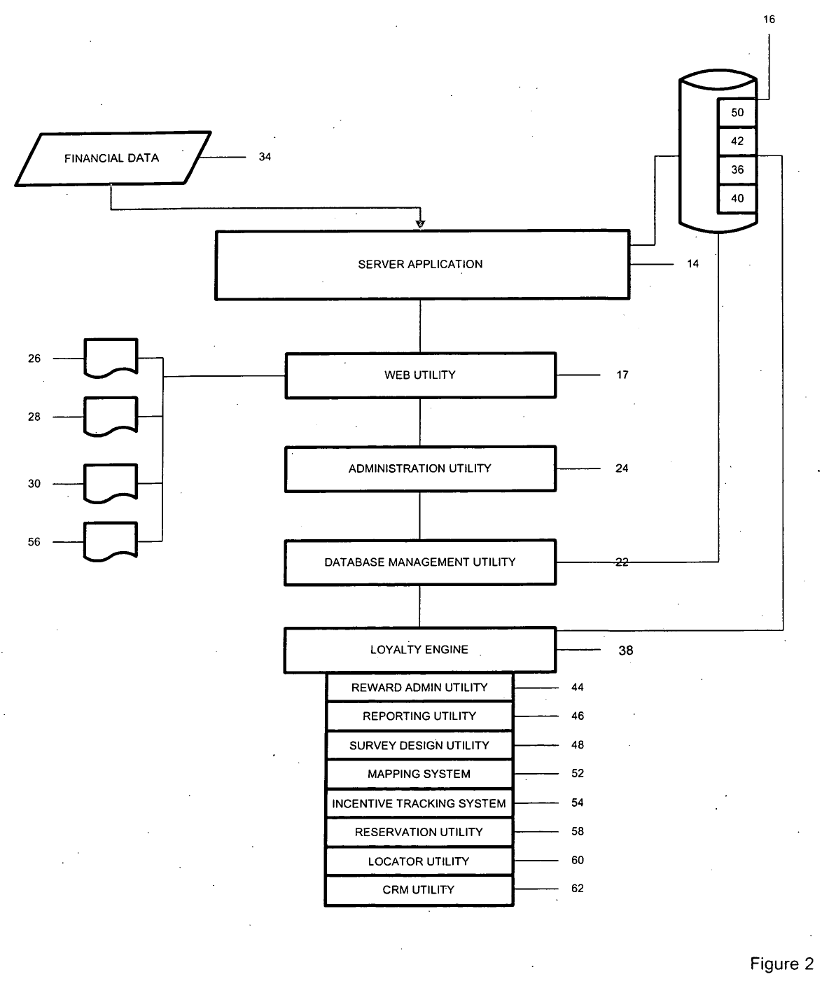

The web site (18) includes a participant area (26) and a member area (28), as illustrated in FIG. 2. Participants are generally understood as individual or corporate users who sign up with the web site (18) for joining one or more of the loyalty programs linked to the operator of the server computer (12).

The participant area (26) consists of a series of web pages containing fields for obtaining sign-up information from participants. The sign-up information includes the name and e-mail address of the particular participant. The participant area (26) also includes a secure area (30), provided in a manner that is known. One aspect of the present invention, is the collection of information from the participants regarding one or more of their financial cards. The financial card information enables the operator of the server computer (12) to track financial transactions of the participant linked to members of the web site (18), as particularized below.

The financial cards include a wide variety of cards such as banking cards or credit cards. In a preferred embodiment of the invention, however, the financial card data consists of credit card data, including a credit card number and expiry date. In a particular embodiment of the present invention, the participant area (26) lists a number of different credits cards and enables participants to select one or more of them, and provide the associated data.

The financial card data is stored to the database (16) based on processes defined by the database management utility (22). In one particular implementation of the invention, financial card data is encrypted and stored to the database (16) in an encrypted form to maintain the security thereof. Alternatively, the financial card data is stored to the database (16) such that retrieval of the financial card data from the database (16) is restricted.

Once the requisite sign-up data has been provided by the participant, the participant is registered to the server computer (12), and by operation of the administration utility (24) the registered participant is provided access to the functions of the server application (14) accessible to participants and described below.

In another aspect of the present invention, the server application (14) is adapted to authenticate participants so as to verify the identity of a participant logging on to the web site (18). In one particular implementation of the present invention, upon completion of the sign-in process described above, the administration utility (24) defines a unique identifier for the participant by operation of a random number generator, in a manner that is known. In the same particular implementation of the present invention, the unique identifier consists of a passphrase or equivalent which is communicated to the participant by means of an e-mail created and sent by operation of the communication utility (20). Thereafter, the participant uses the passphrase to login to the web site (18), which is passed to the administration utility (24) in order for the participant to obtain access to the functions of the server application (14) described below.

One or more members also sign up with the operator of the server computer (12). The members consist of businesses who are interested in obtaining access to the loyalty solution provided by the operator of the server computer (12). The web site (18) also includes the member area (28) that provides access to functions (including administrative functions) described below. Members also sign-up with the administration utility (24) by providing requisite identification data, and by obtaining authentication data, in accordance with processes similar to the sign-up procedures for participants identified above. The sign-up of members with the administration utility (24) enables access by members to participant data linked to the particular member, as described below.

In another aspect of the present invention, the operator of the server computer (12) obtains identification data for the members from the operator of the financial cards. In one particular implementation of the present invention, members provide their credit card merchant authorization. This generally consists of an alphanumeric code that identifies the particular merchant or member.

In an aspect of a particular implementation of the present invention, the operator of the server computer (12) obtains consent from the member and the participant to enter into an arrangement with the one or more financial card companies selected by the participant, as described above. The operator of the server computer (12) creates a data link with the holder of financial card data for each participant.

For example, the operator of the server computer (12) approaches an entity processing credit card transactions or transaction processor (32), and provides parameters for filtering the credit card transaction data for the participant to obtain credit card transaction data of interest, namely credit card transactions of the participant associated with one or more members who have registered with the operator of the web site (18). The filtering generally occurs by means of a database query made by the transaction processor (32) based on a data set that includes the credit card number of the participant and the merchant authorization number of a particular member.

The transaction processor (32) provides financial data (34) to the operator of the server computer (12), which includes: an identifier for the participant, an identifier of the member from which a purchase was made, the settlement date and the amount that the participant spent with the member. The transfer of the financial data (34) occurs through a secure manner, for example, using secure transmissions such as Secure Sockets Layer (SSL) or encryption/decryption using a known method such as PKI.

As a measure for improving security, the parameters provided by the operator of the server computer (12) to the transaction processor (32) include a unique data tag (36) defined by the operator of the server computer that is not the same as the participant's financial card data. The financial data (34) includes the data tag (36) and not the financial card data such as the participant's credit card information.

In one particular implementation of the present invention, the data tag (36) consists of identifying the financial card of the participant by providing to the transaction processor (32) (and then receiving as part of the financial data (34)) only some of the numbers comprising the financial card data such as a credit card number. For example, in a particular implementation of this aspect of the invention, the first four digits of a credit card are left out. With current credit card numbers, the remaining digits are sufficient for the transaction processor (32) to identify the participant. If there is a breach of security, however, this information will not be sufficient to commit fraud using the information.

The server application (14) also includes a loyalty engine (38). The loyalty engine (38) is best understood as an aspect of the database management utility (22), configured to execute the loyalty operations described in the invention. The loyalty engine (38) is linked to the database (16). The loyalty engine (38) creates on the database (16) a loyalty account (40) for each participant, which is used to record the then current loyalty credits accumulated by the participant by operation of the present invention. There is generally a loyalty account (40) per participant, per member registered to the web site (18).

Upon receipt of financial data (34) at the communication utility (20), the loyalty engine (38) is operable to process the financial data (34) and credit the appropriate loyalty account (40). Another aspect of the loyalty engine (38) is that it applies for each member/participant the then applicable loyalty rules (42) for calculating the loyalty benefit that is available to each participant, based on the balance of their loyalty account (40).

The loyalty engine (38) includes a reward administration utility (44). This is a utility that is accessible to members via the member area (28). It allows the members to define and dynamically update the parameters for award and redemption of awards for the loyalty accounts (40) for participants associated with the particular members. The reward administration utility (44) provides a series of interfaces for defining:
Activities required to earn loyalty points (e.g. purchase meeting a certain threshold, purchase at a particular location that is currently underutilized, purchase at high capacity time intervals, and so on).
Quantum of loyalty points assigned to particular activities.
Prizes available by redemption of loyalty points (prizes include discounts).
Number of loyalty points required for particular prizes.
The rules (if any) for obtaining certain prizes by purchasing a top-up of loyalty points for monetary (non-loyalty point) consideration. For example, members can be permitted to purchase points (e.g. by credit card) for a defined amount.

It should be understood that the members are permitted to adjust the values associated with any particular loyalty program on the fly, if they so desire. This combined with the reporting functions of the present invention described above enable the members to customize loyalty benefits that maximize their revenue and/or profitability (or achieve other objectives).

Another aspect of the present invention is that the reward administration utility (44) includes or provides access to a series of reward program templates that assist in designing a reward program. Another aspect of the reward administration utility (44) is that it provides access to text and graphics (such as charts) assisting in the design of an effective reward program. In one particular implementation of the present invention, web pages are displayed in the member area (28) that are used to obtain input from the member required to design/implement a particular reward program, and that also contain general information on designing effective reward programs.

Yet another aspect of the present invention is that members report on the effectiveness of reward programs operated by means of the present invention, and the reward administration utility (44) recommends alterations to the reward program that are likely to achieve improvement of results.

The participants that log in to the participant area (28), are provided access to one or more web pages linked to their loyalty account(s) (40). The information displayed on these web pages are updated in a manner that is known by operation of the server application (14), that obtains access from the loyalty engine (38) of the then current loyalty account (40) values. The participants who have logged in to the participant area (28) are also provided access to some aspects of the loyalty engine (38) for the purpose of redemption of their loyalty points.

In a particular implementation of the present invention, the loyalty engine (38) creates a coupon for a particular member upon receipt of a request from the participant to make an authorized redemption. The participant prints the coupon and presents same for the applicable reward at business premises of the member. In a particular aspect of the present invention, the coupon includes a unique identifier such as a coupon tag or bar code data.

It is preferable for the member to report to the operator of the server computer (12) when a particular coupon has been delivered for the applicable reward. This data is then accessed by the reporting utility (46) to assess the effectiveness of the reward, as explained below.

Another aspect of the present invention, is that the redemption activities of the participant are preferably tied to the participant filling out one or more surveys (50) regarding the member. This may be required by the operator of the server computer (12):
Upon sign-up.
Prior to redemption of a reward.

The surveys can be designed to obtain feedback from customers on a number of different matters. The loyalty engine (38) includes a survey design utility. The survey design utility (48) includes a series of survey templates as well as instructions for designing an effective survey (50). The parameters of each survey created by a member are stored to the database (16). The server application (14) is adapted to publish the various surveys (50) as a web page accessible to the participants via the participant area (26).

The surveys (50) generally consist of a plurality fields that are completed by participants. The data from the various completed surveys is then stored to the database (16) in a manner that is known. The data included by participants into the various surveys (50) associated with a particular member is available to that member. This data can be utilized for a number of business purposes, including service improvements. One aspect of the surveys (50) is to solicit feedback on the effectiveness of the loyalty program overall. This data can be used by members to adjust their loyalty programs by operation of the loyalty engine (38), in response to the feedback provided by the survey.

Members will generally associate a reward incentive with the completion of a survey (50).

One of the advantages of the present invention is that it provides ready access to the data included in the surveys (50). It has generally been found to be difficult to have customers fill out surveys, and therefore the response ratios have been quite low. Providing the survey on-line, in combination with a loyalty program familiar to the participant, and particularly as part of an activity that will result in or is associated with a loyalty reward, has been found to improve this ratio significantly.

It should be understood that the present invention enables members to receive information regarding the activities of participants in real time. By operation of the reporting utility (46) (in co-operation with the communication utility (20), for example, escalation procedures can be established such that if a customer fills out a survey (50) indicating that she was “NOT SATISFIED” with a particular product or services, an alert can be communicated to the member, which is used to create an action item (such as a call to particular participant to obtain details on the circumstances leading to the negative survey entry, and with a view to a accommodating the participant).

The reporting utility (46) enables a plurality of reporting functions based on the financial data (34), activities of participants in relation to their loyalty account (40), and survey data, including:
A mapping system (52) that tells (and displays in a map) to the member where participants making purchases originate from.
An incentive tracking system (54) that allows the member to track loyalty points that have been redeemed, including at particular locations.
The incentive tracking system (54) also allows the member to track how much each incentive makes or costs. For example, the member enters by logging on to the server application (14), and updating the records of the incentive tracking system (54) by operation of a suitable web interface. The reporting utility (46) cooperates with the incentive tracking system (54) such that the incremental revenue and incremental cost is recorded in an incentive reward file. At any point, the member can determine the incremental revenue, costs and net by individual or all incentives, by operation of the reporting utility (46).

It should be understood that a number of other related functions can be added to the. reporting utility (46) in a manner that is known.

The functions of the reporting utility (46) enable the members to assess the effectiveness of specific loyalty reward programs and to make adjustments on an ongoing basis by operation of the reward administration utility (44).

In another aspect of the present invention, the server application (14) supports relationships between particular members and sponsors. Sponsors may provide, for example, certain goods or services for promotional purposes, which goods or services are used by members as a loyalty reward. The server application (14) also defines a sponsor area (56) on the web site (18) which enables sponsors to review:
Data regarding sponsor's goods/services that have been redeemed.
Particulars of such redemptions (including for example geographic location).
Data regarding particular participants who have redeemed goods/services of the sponsor.

The advantage for sponsors is that it enables the distribution of goods/services into target markets of interest at a relatively small cost. For example, in the case of a member who is a golf course, the sponsor might be an athletic clothing manufacturer (e.g. of golf shirts). Brand promotion is often a costly exercise involving the organization of golf tournaments, visits to the golf course, placements of goods, and follow up sales calls. The provision of golf shirts as part of a loyalty reward program administered by the golf course can reduce a number of the customary steps in the brand promotion process. More importantly, promotion of the golf shirt brand will enhance the perceived value of the reward being provided by the golf course. Consequently, the present invention provides incentives for the golf course to promote the brand of the golf shirt manufacturer.

This merely illustrates some of the cross-promotional benefits of the present invention. The present invention acts as a platform for a plurality of companies for testing cross-promotional activities, obtaining feedback real time on how participants rate offers and their effectiveness, and making adjustments to cross-promotional elements of a particular loyalty program over time. This provides better coverage to companies, and also more targeted marketing to selected market groups. This merely illustrates some of the cross-promotional benefits of the present invention. The present invention acts as a platform for a plurality of members (merchants) to use cross-promotional activities, for increased cost effectiveness. Members receive feedback when customers evaluate and rate reward offers, providing real time feedback on their effectiveness as well as the performance of the recent service.

Participating members directly access cross-promotional offers among other participating members and negotiate these directly with other participating members. The system provides better coverage to members than they get from other methods and allows targeted marketing to selected market groups. The system also provides direct tracking of incremental spending by location and identifies to the member where the participant comes from.

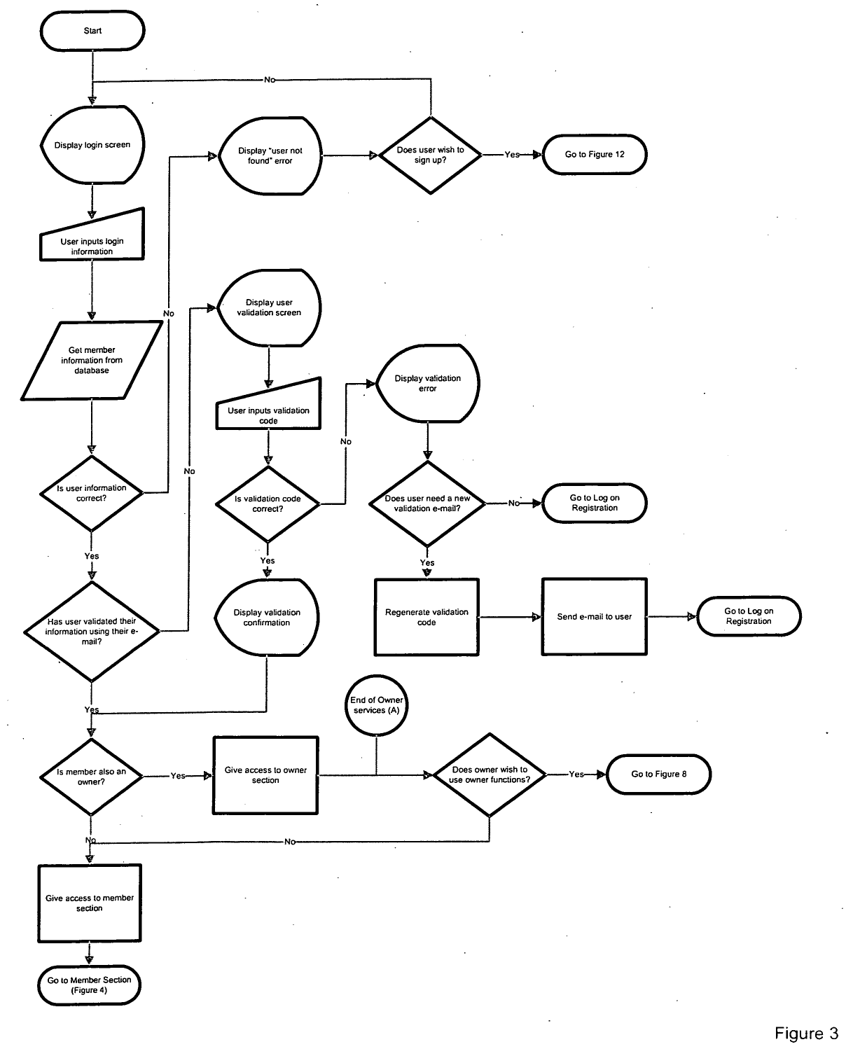

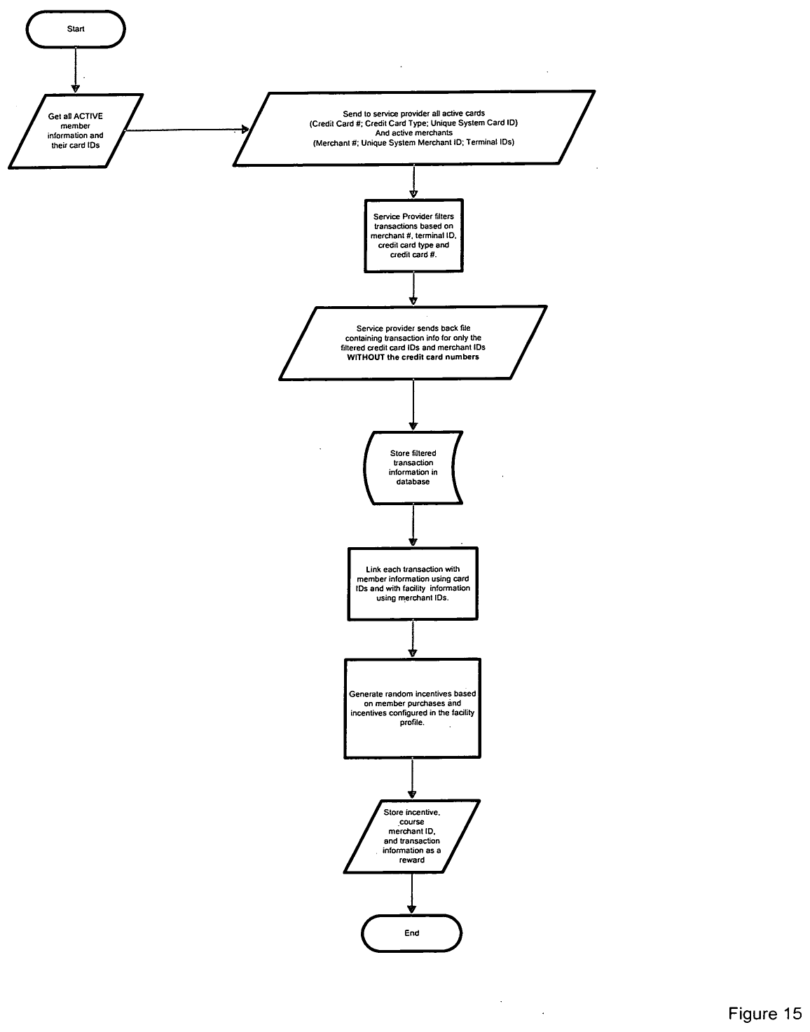

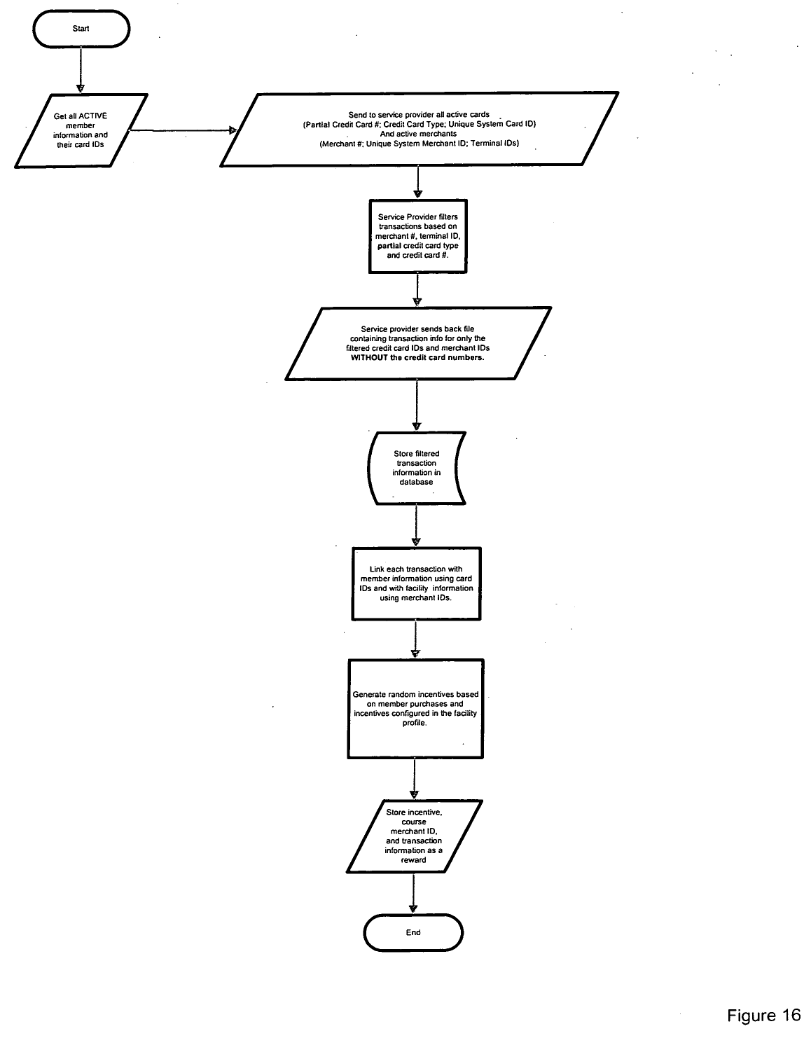

FIGS. 3-16 illustrate particular aspects of the present invention.

FIG. 3 is a flowchart illustrating the log-in/registration process for participants and members, as defined by operation of the administration utility.

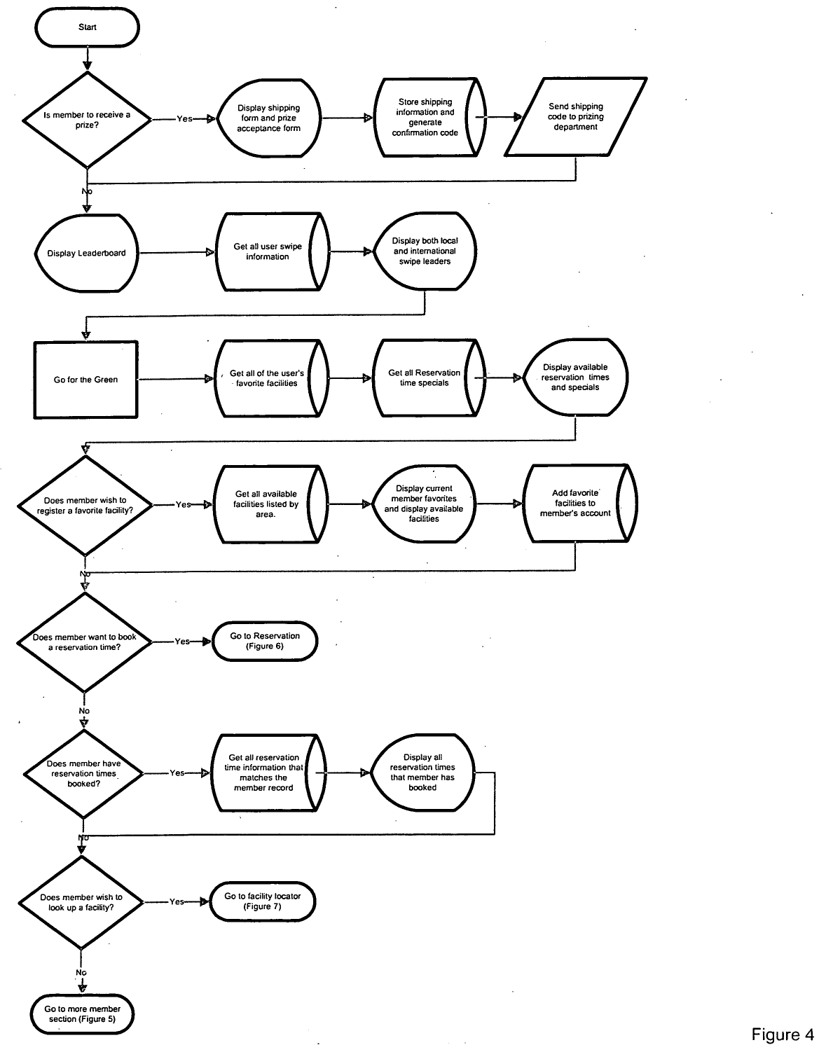

FIG. 4 is a flowchart illustrating the processes involved in a particular embodiment of the participant area (26). In this embodiment of the present invention, the server application (14) includes a reservation utility (58). The reservation utility (58) is a known utility for making reservations by a series of web interfaces. This is a useful resource to associate with the server computer (12) where the member sells goods or services in relation to which it is useful to make a reservation. This is the case with golf courses, restaurants, in-store seminars at hardware stores, and the like. This is particularly advantageous as it then enables the members to provide loyalty rewards to participants that also involve a reservation either at a location of the member, or an affiliated member or sponsor (e.g. a loyalty reward provided by one member is dinner at the restaurant of another member or sponsor, where the reservation is booked by operation of the reservation utility (58). FIG. 4 illustrates operation of the reservation utility in relation to a member facility that is a golf course.

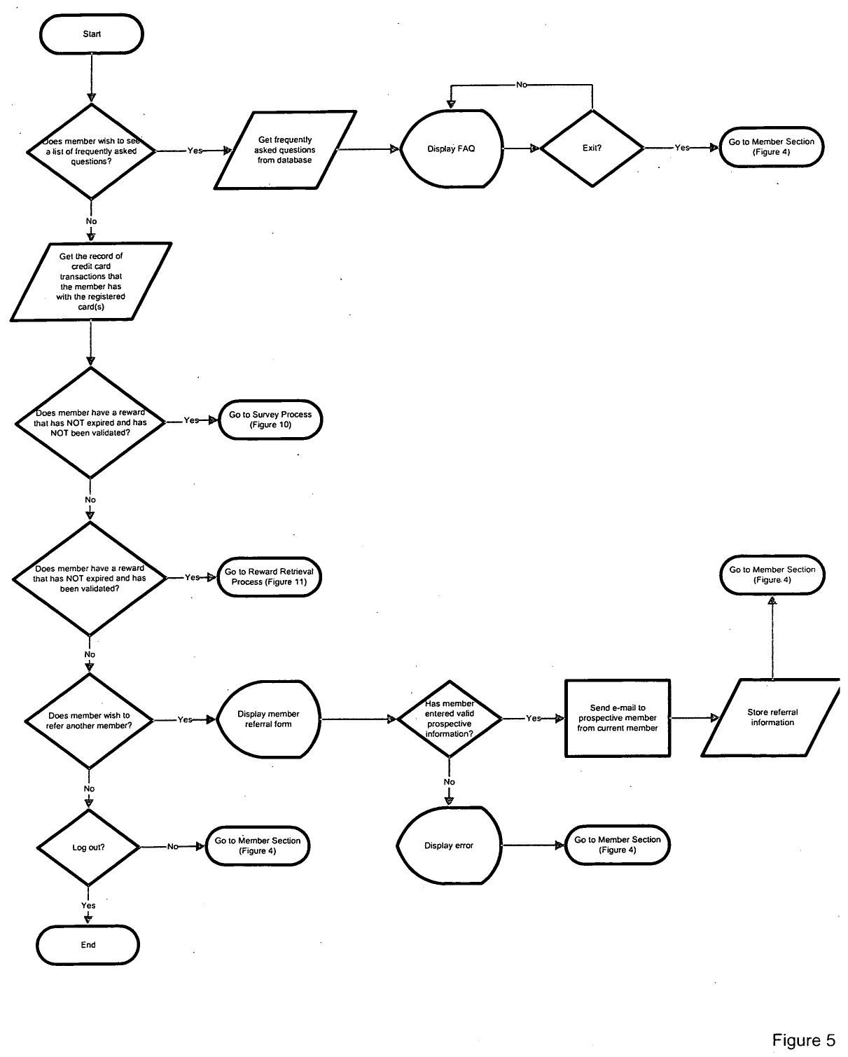

FIG. 5 illustrates further processes involved in a particular embodiment of the participant area (26), including the registration/log-in process for participants whereby the financial card information for participants is obtained. FIG. 5 also illustrates a particular feature of the present invention whereby participants are invited by means of a web page to invite others whom they know to also become participants.

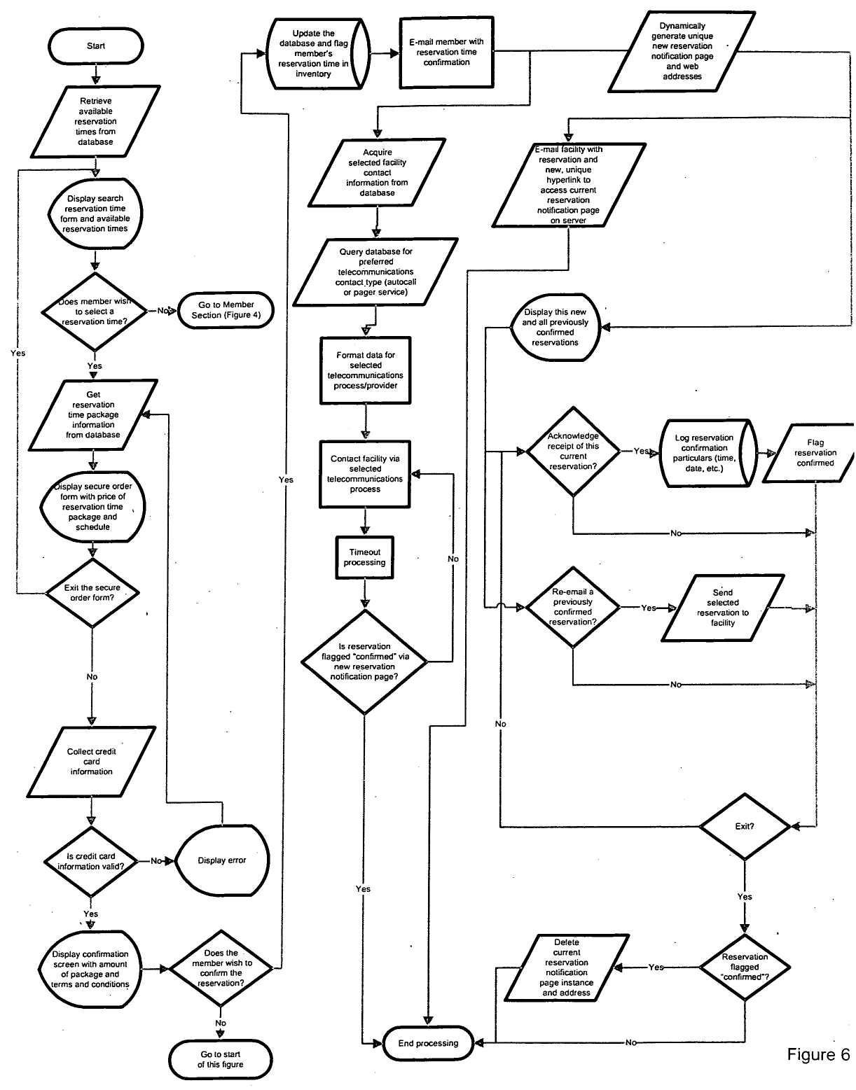

FIG. 6 illustrates in greater deal the operation of the reservation utility (58), in a particular embodiment of the thereof.

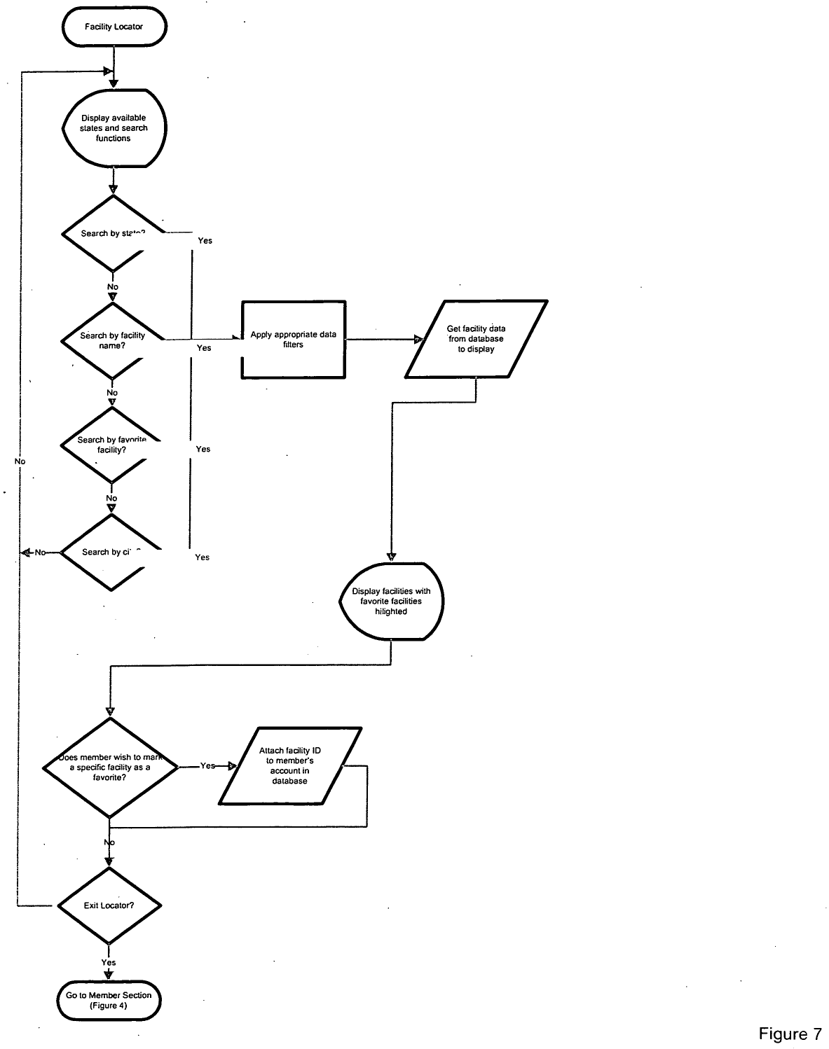

FIG. 7 illustrates the operation of the locator utility (60), which is a feature of the server application (14), in one particular embodiment thereof. The locator utility (60) permits participants to search for particular locations/facilities of a particular member based on geography. The locator utility (60) is a known utility that enables participants to perform a look-up function from a table of member locations to find the location closest to a defined geographic location provided by the participant.

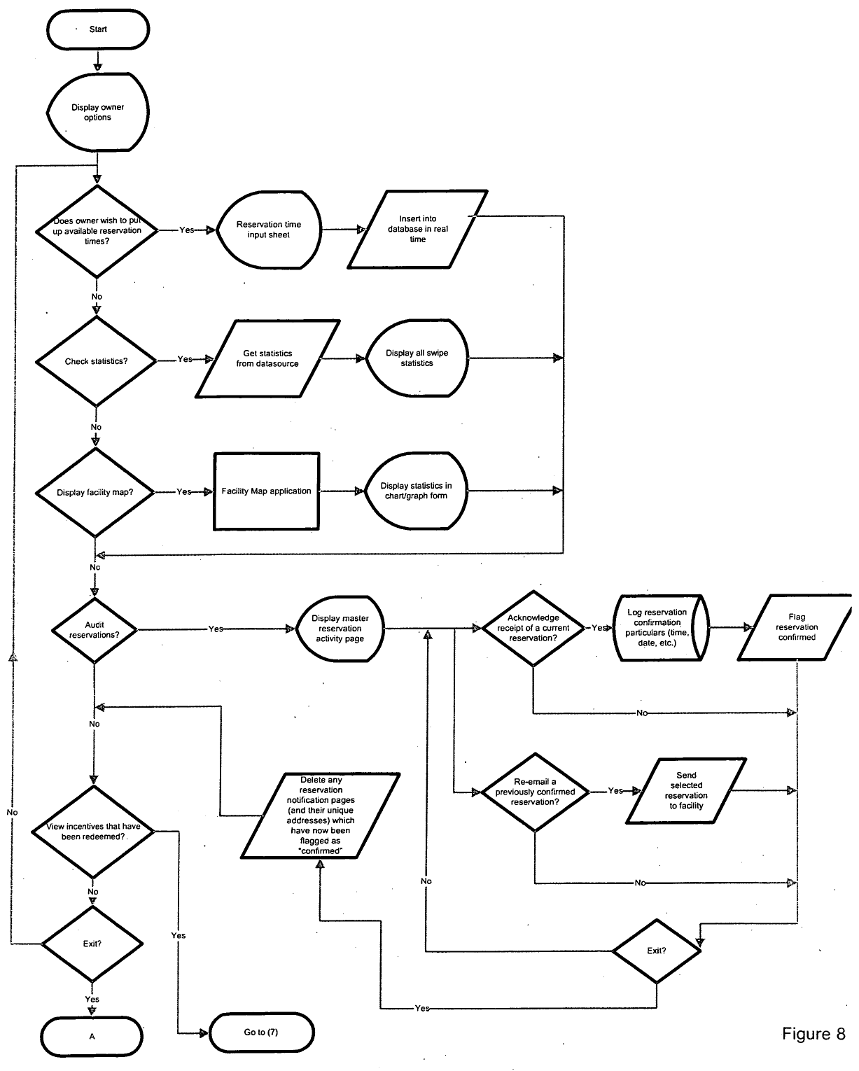

FIG. 8 illustrates a plurality of functions provided in association to the member area (28), and in particular the preferences set by members by operation of the administration facility (24) defining preferences regarding reservation times, financial card data statistics, facility maps, and audit of reservations.

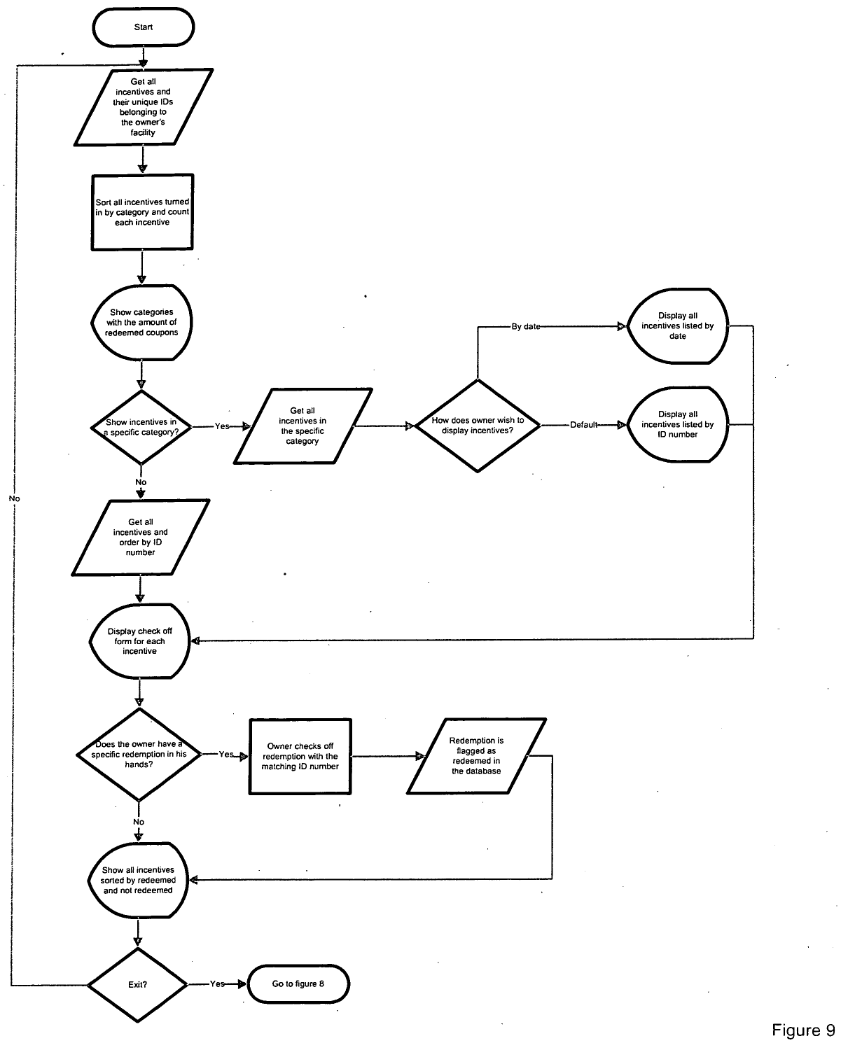

FIG. 9 illustrates a plurality of processes enabled by operation of the loyalty engine (38) for the creation of loyalty programs, in accordance with one particular aspect of the present invention.

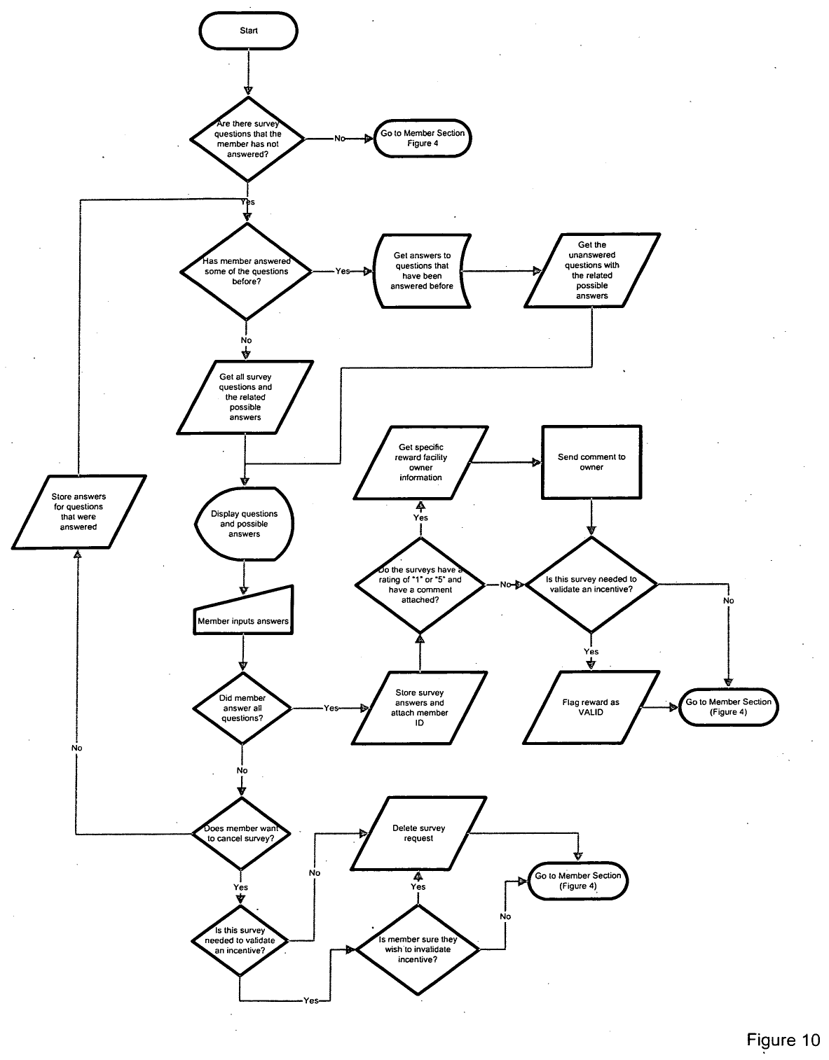

FIG. 10 is a flowchart that illustrates a plurality of processes enabled by operation of loyalty engine (38) in relation to surveys (50) for completion by participants.

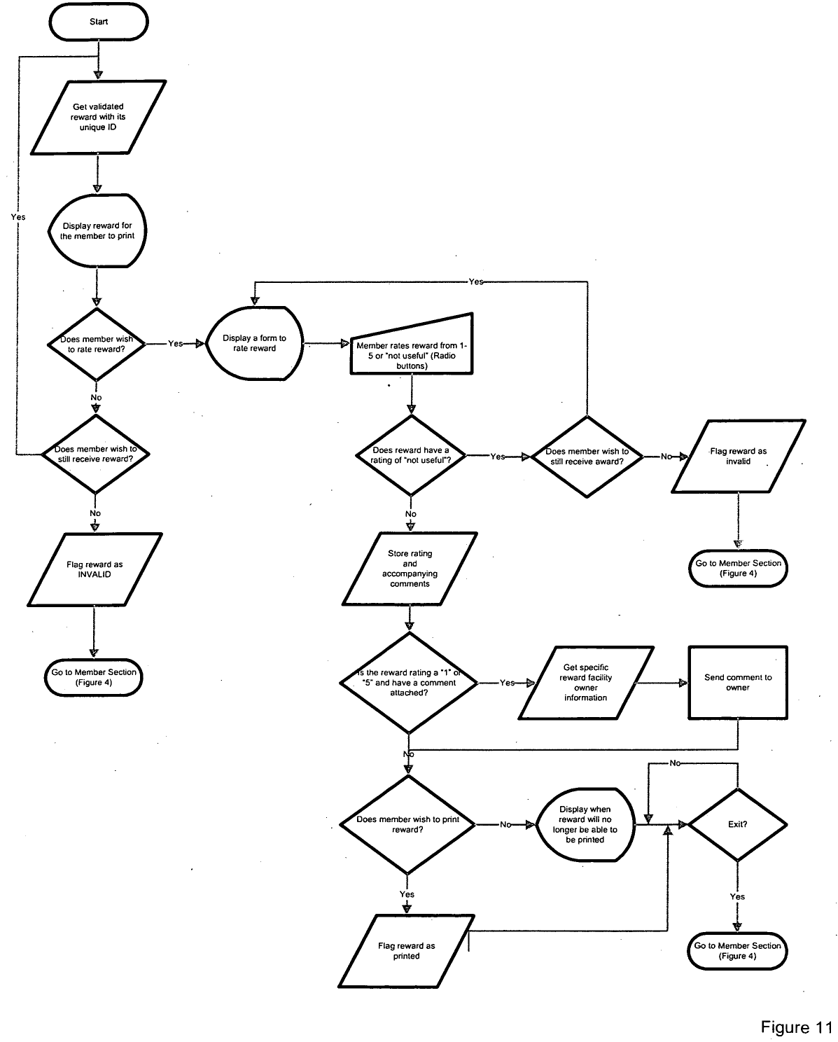

FIG. 11 is another flowchart that illustrates a plurality of processes related to the redemption of loyalty rewards by participants, by operation of the loyalty engine (38).

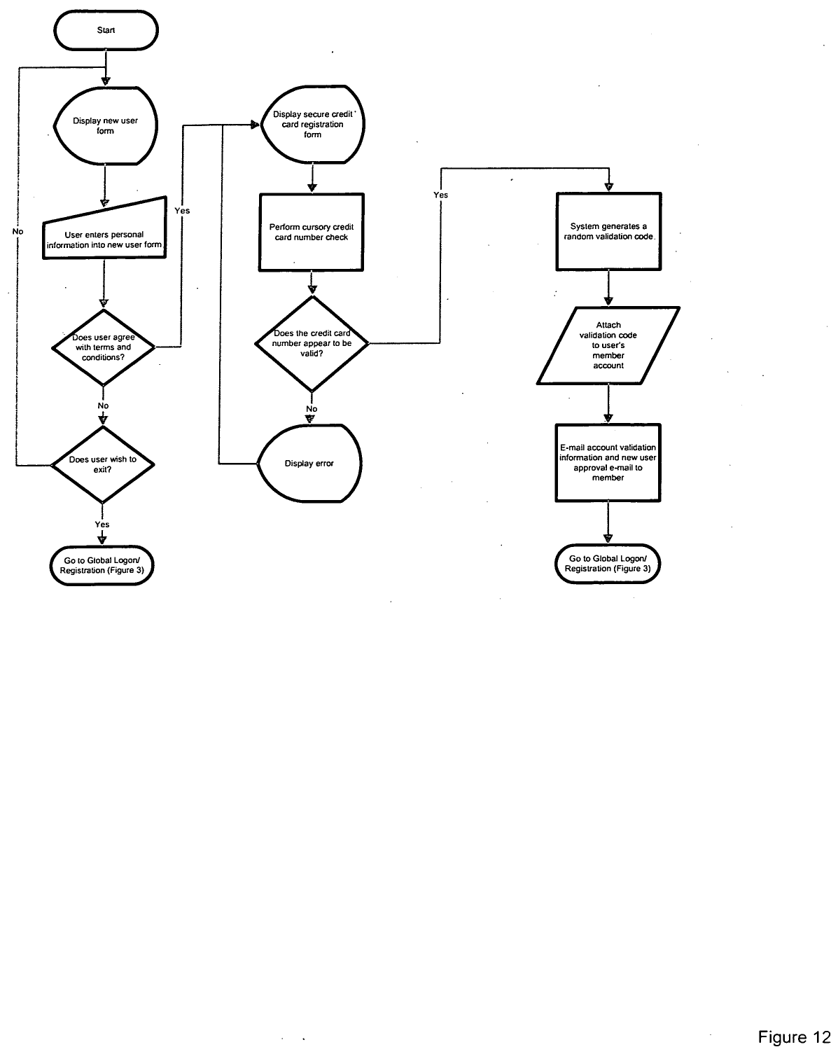

FIG. 12 is a further flowchart that illustrates certain processes related to the registration of participants to the web site (18).

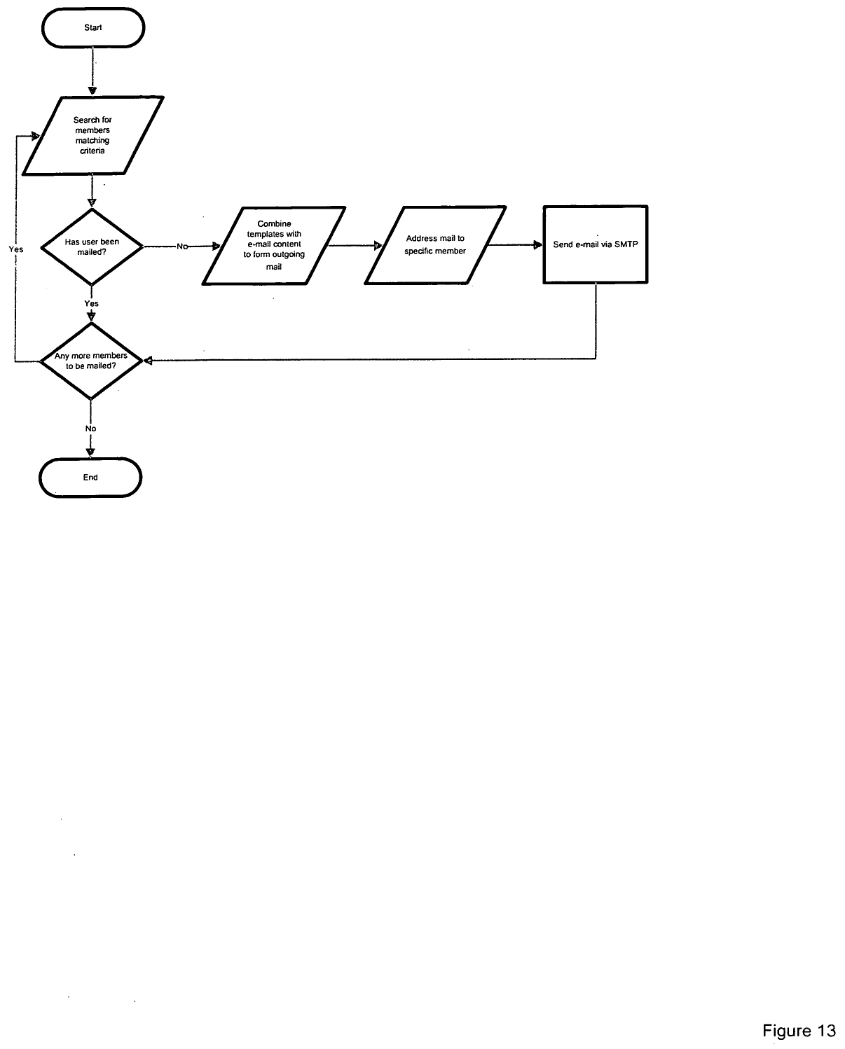

FIG. 13 illustrates a further aspect of the server application (14) of the present invention consisting of a Customer Relationship Management or CRM utility (62). The CRM utility (62) is a known software utility that enables managed communications with customers. The CRM utility (62) can incorporate numerous typical CRM functions as part of a web-enabled ASP application part of the server application (14). For example, as illustrated in FIG. 13, the CRM utility (62) is operable in co-operation with the communication facility (20) to send messages to a participant mailing list, including for example emails regarding special promotions.

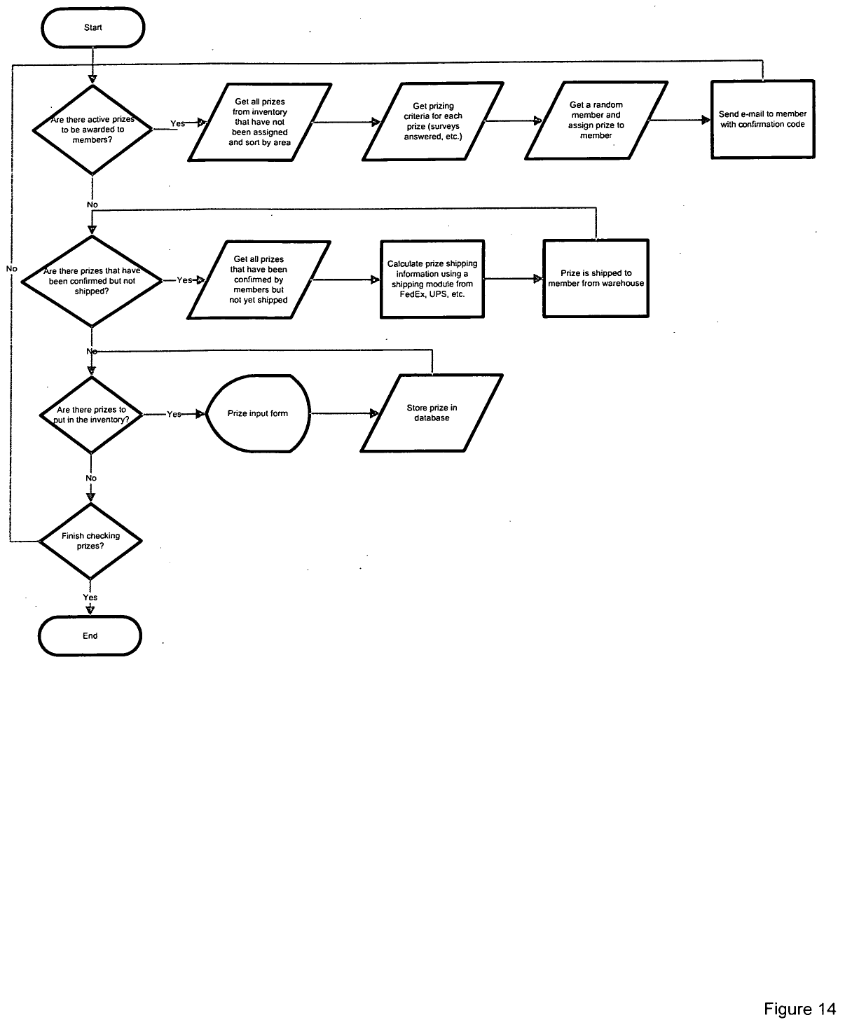

FIG. 14 is a flowchart illustrating a particular aspect of the reward administration facility, namely the processes involved in awarding prizes to participants.

Other extensions of the present invention are possible. Additional features can be added to the server application, and its various utilities described in this disclosure, without departing from the invention.

1. A method of encouraging customer loyalty, comprising the steps of:
(a) One or more members defining a loyalty program, the loyalty program defining loyalty reward points associated with one or more activities;
(b) Registering one or more participants with the loyalty program, whereby their registration includes the provision of financial card data for one or more financial cards of each of the one or more participants;
(c) Collecting financial data corresponding to transactions of the one or more participants associated with the one or more members, and providing said financial data to a loyalty engine; and
(d) Providing access to the loyalty engine to the one or more members, the loyalty engine permitting the one or more members:
(i) To define the rules defining the loyalty program, including accumulation of the loyalty reward points, and redemption of the loyalty reward points
(ii) Monitoring the effectiveness of the loyalty program; and
(iii) Modifying the loyalty program to enhance its effectiveness.

2. The method of claim 1, comprising the further step of requiring the one or more participants to fill out a survey regarding the one or more members.

3. The method of claim 2, comprising the further step of the one or more members defining the contents of the survey.

4. The method of claim 3, comprising the further step of linking loyalty reward points to completion of the survey.

5. The method of claim 1, comprising the further steps of:
(a) Defining a unique identifier for each participant;
(b) Providing the unique identifier and merchant authorization data for the one or more members to a transaction processing entity for the one or more financial cards; and
(c) Filtering financial card transactions processed by the transaction processing entity for each participant to select the financial card transactions associated with the one or more members;
(d) Providing data corresponding to the selected financial card transactions to the operator of the loyalty engine.

6. The method of claim 5, whereby the data corresponding to the selected financial card transactions includes one or more of the following:
(a) The unique identifier;
(b) Identification data for the member; and
(c) Settlement date and the amount the participant spent with the member.

7. The method of claim 1, comprising the further step of providing reports to the one or more members reporting on the effectiveness of the loyalty program, the reports assisting in the modification of the loyalty program to improve the effectiveness thereof.

8. A system for encouraging customer loyalty, the system being operable to connect to one or more remote computers to provide access to the resources of the system at said one or more remote computers, the system comprising:
(a) A server computer;
(b) A server application linked to the server computer, the server application including a loyalty engine, the server application being operable to provide instructions to the server computer that:
(i) Enable one or more members to define rules for a loyalty program, the loyalty program including loyalty reward points associated with one or more activities;
(ii) Register one or more participants with the loyalty program, wherein the registration includes the provision of financial card data for one or more financial cards of each of the one or more participants; and
(iii) Collect financial data corresponding to transactions of the one or more participants associated with the one or more members, and providing said financial data to a loyalty engine; and
Wherein the loyalty engine is operable on the server computer to enable the members to:
(i) To modify the rules for the loyalty program on a dynamic basis, including rules for accumulation of loyalty reward points, and redemption of loyalty reward points;
(ii) Monitoring the effectiveness of the loyalty program; and
(iii) Modifying the loyalty program to enhance its effectiveness.

9. The system claimed in claim 8, wherein the server application is operable to collect survey data from participants.

10. The system claimed in claim 9, wherein the server application is operable to link loyalty reward points to provision of survey data, by operation of the loyalty engine.

11. The system claimed in claim 9, wherein the server application is operable to:
(a) Establish a unique identifier for each participant;
(b) Provide the unique identifier and merchant authorization data for the one or more members to a remote transaction processing system associated with the one or more financial cards;
(c) Receiving selected financial card transaction data from the remote transaction processing system corresponding to the financial card transactions associated with the one or more members for the participant; and
(d) Applying the selected financial card transaction data to the loyalty engine, thereby applying the rules for the applicable loyalty program to the selected financial card transaction data.

12. The system claimed in claim 12, wherein the selected financial card transaction data includes:
(a) The unique identifier;
(b) Identification data for the member; and
(c) Settlement date and the amount the participant spent with the member.

13. The system as claimed in claim 9, wherein the server computer is linked to a database and the server application includes a database management utility for managing the storage and retrieval of data from the database related to the operation of the loyalty engine, wherein the database management utility is operable to encrypt to the database personal information provided by the participants.

14. The system as claimed in claim 9, wherein the server application includes an administration facility that enables hierarchical access to participants or members to functions of the server application or data stored to the database, based on permissions defined by the operator of the server computer.

15. The system as claimed in claim 9, wherein the server application is operable to publish a series of web pages to the Internet, wherein the web pages include:
(a) One or more web pages defining a participant area that provides access to functions of the server application dedicated to participants; and
(b) One or more web pages defining a member area that provides access to functions of the server application dedicated to members.

16. The system as claimed in claim 15, wherein the server application includes a reward administration utility that enables members to modify the rules for one or more of their loyalty programs, wherein the reward administration utility is operable to enable members to perform one or more of the following functions:
(a) Definition of the activities required to earn loyalty reward points;
(b) Definition of the quantum of loyalty reward points assigned to particular activities;
(c) Prizes available by redemption of a specific quantum of loyalty reward points; and
(d) Rules for permitting participants to purchase loyalty reward points for monetary consideration.

17. The system as claimed in claim 9, wherein the server application includes a reporting utility, wherein the reporting utility is operable to analyze data stored to the database associated with participant accumulation and redemption of loyalty reward points to populate one or more reports, and present the reports to the associated member, the reports assisting the member in modifying the rules for one or more of their loyalty programs to improve their effectiveness.

18. The system claimed in claim 15, wherein the member area enables participants to:
(a) access a loyalty account that reflects a substantially real time loyalty point balance; and
(b) redeem loyalty reward points for associated prizes based on the loyalty reward point balance.

19. A computer program product, for use on a server computer, the computer program product comprising:
(a) A computer usable medium;
(b) Computer readable program code recorded or storable in the computer useable medium, the computer readable program code defining a server application on the server computer that is operable on the server computer to:
(i) Enable one or more members to define rules for a loyalty program, the loyalty program including loyalty reward points associated with one or more activities;
(ii) Register one or more participants with the loyalty program, wherein the registration includes the provision of financial card data for one or more financial cards of each of the one or more participants;
(iii) Collect financial data corresponding to transactions of the one or more participants associated with the one or more members, and providing said financial data to a loyalty engine; and
Wherein the loyalty engine is operable on the server computer to enable the members to:
(iv) To modify the rules for the loyalty program on a dynamic basis, including rules for accumulation of the loyalty reward points, and redemption of the loyalty reward points;
(v) Monitoring the effectiveness of the loyalty program; and
(vi) Modifying the loyalty program to enhance its effectiveness.

20. A computer program product as claimed in claim 19, wherein the loyalty engine includes a reward administration utility that enables members to modify the rules for one or more of their loyalty programs, wherein the reward administration utility is operable to enable members to perform one or more of the following functions:
(a) Definition of the activities required to earn loyalty reward points;
(b) Definition of the quantum of loyalty reward points assigned to particular activities;
(c) Prizes available by redemption of a specific quantum of loyalty reward points; and
(d) Rules for permitting participants to purchase loyalty reward points for monetary consideration.
